(19) United States
(12) Patent Application Publication
(10) Pub. No.: US 2021/0333595 A1
(43) Pub. Date: Oct. 28, 2021

(54) LIQUID CRYSTAL DISPLAY PANEL AND METHOD FOR MANUFACTURING THE SAME

(71) Applicant: SHENZHEN CHINA STAR OPTOELECTRONICS SEMICONDUCTOR DISPLAY TECHNOLOGY CO., LTD., SHENZHEN (CN)

(72) Inventor: XIANGWEI JIANG, SHENZHEN (CN)

(21) Appl. No.: 16/607,110

(22) PCT Filed: Sep. 13, 2018
(86) PCT No.: PCT/CN2018/105369

§ 371 Date: Oct. 22, 2019

(30) Foreign Application Priority Data
Jul. 2, 2018 (CN) 201810705050.8

(51) Int. Cl. G02F 1/1339; G02F 1/1335; G02F 1/1368; G02F 1/1345; G02F 1/1362; G02F 1/1341

(52) U.S. Cl. CPC G02F 1/13394; G02F 1/133514; G02F 1/1368; G02F 1/13396; G02F 1/13398; G02F 1/136286; G02F 1/1341; G02F 1/13454

(57) ABSTRACT

A liquid crystal display panel is provided and includes an array substrate, which includes a display region and a non-display region. The non-display region is provided with a gate driver on array (GOA) signal line and a frame sealant located above the GOA signal line. A spacer layer includes a first spacer disposed near an edge of the display region, a second spacer disposed and distributed in the display region, and a third spacer disposed in the non-display region, located between the GOA signal line and the frame sealant.

### FIELD OF THE INVENTION

The present disclosure relates to the technical field of displays, and in particular, to a liquid crystal display panel and a method for manufacturing the same.

### BACKGROUND OF DISCLOSURE

With the development of liquid crystal panel technology, high quality and low cost are the two major development directions for the liquid crystal display (LCD) panel industry. In terms of high quality, narrow frame width technology is favored by consumers for the visual effect, and has become a trend of industry development. In terms of low cost, the costs of Chips-on-Flex, or Chips-on-Film (COF) components account for a large part of the overall costs of display panels. To minimize the number of COFs is also an important development direction for the LCD panel industry. The introduction of Gate Driver on Array (GOA) technology solve the above two problems. COFs are replaced by GOAs, and GOAs integrate the scan circuits onto the panel, thereby reducing the frame width close to a gate drive module, and saving the costs of COFs.

However, in order to ensure the reliability of a GOA circuit, it is required for a GOA signal line to be away from the frame sealant, to prevent the GOA signal line from corrosion by water vapor invasion under extreme testing conditions when the sealing is not tight enough. Thus, further reduction of the frame width closed to the gate drive module is difficult. Based upon a conventional design, the frame sealant covers a part of the GOA signal line, in order to further reduce the frame width, but brings two serious problems. Firstly, the via hole for the GOA signal line is also located under the frame sealant. Since the GOA signal line is a high frequency signal, the resistance of the GOA signal line on the via hole position is greater than the signal line, and more heat is generated on the via hole position than other parts. Under extreme testing conditions, water vapor invasion first corrodes the via hole position, and causes failure of the liquid crystal panel. Thus, the reliability of the liquid crystal panel does not meet the customers' demand. Secondly, particles (environmental particles) are everywhere in the panel manufacturing process. When falling into the via hole, particles cause the GOA signal line and the indium tin oxide (ITO, common electrodes) of the color filter substrate to be short-circuited, so that the GOA signal is abnormal, the panel cannot properly illuminate, and the yield rate is decreased.

In summary, in the conventional liquid crystal display panel, in order to realize the narrow frame width, it is required for the frame sealant to cover a part of the GOA signal line, thereby resulting in the defects of serious heat generation of the GOA signal line on the via hole position, corrosion to the via hole invaded by water vapor, and the abnormal function of the GOA signal line caused by the particles falling into the via hole.

### SUMMARY OF INVENTION

The present disclosure provides a liquid crystal display panel. An isolation layer is disposed on a surface of the GOA signal line to solve the defects of serious heat generation of the GOA signal line on the via hole position, corrosion to the via hole invaded by water vapor, and the abnormal function of the GOA signal line caused by the particles falling into the via hole due to the frame sealant covering a part of the GOA signal line.

To solve the above problems, the technical solution provided by the present disclosure is as follows:

The present disclosure provides a liquid crystal display panel, comprising:

an array substrate;

a color filter substrate disposed opposite to the array substrate; and

a frame sealant disposed between the array substrate and the color filter substrate;

wherein the array substrate comprises:

a display region;

a non-display region located outside the display region;

a thin film transistor array disposed in a display region of the array substrate;

a gate driver on array (GOA) signal line disposed in the non-display region of the array substrate; the frame sealant being located above the GOA signal line; and

a spacer layer comprising:

a first spacer disposed near an edge of the display region;

a second spacer disposed and distributed in the display region; and

a third spacer disposed in the non-display region, located between the GOA signal line and the frame sealant, and completely covers or partially covers the GOA signal line.

In accordance with a preferred embodiment of the present disclosure, the first spacer, the second spacer, and the third spacer are made from a same material.

In accordance with a preferred embodiment of the present disclosure, the first spacer, the second spacer, and the third spacer are made from an ultraviolet (UV)-curable acryl resin material.

In accordance with a preferred embodiment of the present disclosure, the first spacer, the second spacer, and the third spacer are formed on a surface of the array substrate by using a same mask process, wherein thicknesses of the first spacer, the second spacer, and the third spacer successively decrease.

In accordance with a preferred embodiment of the present disclosure, the third spacer has a thickness ranging from 0.2 um to 0.8 um.

In accordance with a preferred embodiment of the present disclosure, the GOA signal line includes a timing signal line, a first insulating layer is disposed on the timing signal line, a scan line is disposed on a surface of the first insulating layer, a second insulating layer is disposed on a surface of the scan line, the scan line extends into the display region and is connected to the thin film transistor array, the timing signal line is approximately perpendicular to the scan line;

a first via hole is formed on the surface of the first insulating layer, a second via hole is formed on the surface of the second insulating layer, a transparent metal layer is formed on surfaces of the first via hole and the second via hole, the transparent metal layer is connected to the timing signal line through the first via hole, and the transparent metal layer is connected to the scan line through the second via hole, and the third spacer at least covers the first via hole and the second via hole.

The present disclosure further provides another liquid crystal display panel, comprising:

an array substrate;

a color filter substrate disposed opposite to the array substrate; and

a frame sealant disposed between the array substrate and the color filter substrate;

wherein the array substrate comprises:

a display region;

a non-display region located outside the display region;

a thin film transistor array disposed in a display region of the array substrate;

a gate driver on array (GOA) signal line disposed in the non-display region of the array substrate; the frame sealant being located above the GOA signal line; and

a spacer layer comprising:

a first spacer disposed near an edge of the display region;

a second spacer disposed and distributed in the display region; and

a third spacer disposed in the non-display region, and located between the GOA signal line and the frame sealant.

In accordance with a preferred embodiment of the present disclosure, the first spacer, the second spacer, and the third spacer are made from a same material.

In accordance with a preferred embodiment of the present disclosure, the first spacer, the second spacer, and the third spacer are made from a ultraviolet (UV)-curable acryl resin material.

In accordance with a preferred embodiment of the present disclosure, the first spacer, the second spacer, and the third spacer are formed on a surface of the array substrate by using a same mask process, wherein thicknesses of the first spacer, the second spacer, and the third spacer successively decrease.

In accordance with a preferred embodiment of the present disclosure, the third spacer has a thickness ranging from 0.2 um to 0.8 um.

In accordance with a preferred embodiment of the present disclosure, the GOA signal line includes a timing signal line, a first insulating layer is disposed on the timing signal line, a scan line is disposed on a surface of the first insulating layer, a second insulating layer is disposed on a surface of the scan line, the scan line extends into the display region and is connected to the thin film transistor array, the timing signal line is approximately perpendicular to the scan line;

a first via hole is formed on the surface of the first insulating layer, a second via hole is formed on the surface of the second insulating layer, a transparent metal layer is formed on surfaces of the first via hole and the second via hole, the transparent metal layer is connected to the timing signal line through the first via hole, and the transparent metal layer is connected to the scan line through the second via hole, and the third spacer at least covers the first via hole and the second via hole.

According to the above object of the present disclosure, the present disclosure provides a method of manufacturing a liquid crystal display panel, comprising steps of:

S10: providing an array substrate, wherein the array substrate defines a display region and a non-display region located outside the display region, a thin film transistor array is disposed in the display region, and a gate driver on array (GOA) signal line is disposed in the non-display region;

S20: preparing a spacer layer on a surface of the array substrate, wherein the spacer layer comprises a first spacer disposed near an edge of the display region, a second spacer disposed in the display region, and a third spacer disposed in the non-display region, and located above the GOA signal line;

S30: disposing a frame sealant in the non-display region, wherein the frame sealant covers a portion of the third spacer;

S40: providing a color filter substrate, and combining the color filter substrate and the array substrate into a cell structure; and

S50: injecting a liquid crystal into the cell structure.

In accordance with a preferred embodiment of the present disclosure, in the step S20, the first spacer, the second spacer and the third spacer are prepared by using a same mask process, wherein thicknesses of a first spacer, the second spacer, and the third spacer successively decrease.

In accordance with a preferred embodiment of the present disclosure, in the step S20, the first spacer, the second spacer, and the third spacer are made of an ultraviolet (UV)-curable acryl resin material.

In accordance with a preferred embodiment of the present disclosure, the GOA signal line includes a timing signal line, a first insulating layer is disposed on the timing signal line, a scan line is disposed on a surface of the first insulating layer, a second insulating layer is disposed on a surface of the scan line, the scan line extends into the display region and is connected to the thin film transistor array, the timing signal line is approximately perpendicular to the scan line;

a first via hole is formed on the surface of the first insulating layer, a second via hole is formed on the surface of the second insulating layer, a transparent metal layer is formed on surfaces of the first via hole and the second via hole, the transparent metal layer is connected to the timing signal line through the first via hole, and the transparent metal layer is connected to the scan line through the second via hole, and the third spacer at least covers the first via hole and the second via hole.

The beneficial effects of the present disclosure are as follows: In the liquid crystal display panel and the method for manufacturing the same provided by the present disclosure, an isolation layer is disposed on the surface of the GOA signal line to avoid contact between the frame sealant covering the GOA signal line and the GOA signal line, thereby solving the defects of serious heat generation of the GOA signal line on the via hole position, corrosion to the via hole invaded by water vapor, and the abnormal function of the GOA signal line caused by the particles falling into the via hole due to the frame sealant covering a part of the GOA signal line.

### BRIEF DESCRIPTION OF DRAWINGS

In order to more clearly illustrate the embodiments of the present disclosure or the technical solutions in prior arts, the following briefly introduces the accompanying drawings used in the embodiments. Obviously, the drawings in the following description merely show some of the embodiments of the present disclosure. As regards one of ordinary skill in the art, other drawings can be obtained in accordance with these accompanying drawings without making inventive efforts.

FIG. 1 is a schematic diagram of a front view of a liquid crystal display panel provided by the present disclosure.

FIG. 2 is a schematic diagram of a film layer structure of a liquid crystal display panel provided by the present disclosure.

FIG. 3 is a flow chart of a process for manufacturing a liquid crystal display panel provided by the present disclosure.

### DETAILED DESCRIPTION OF PREFERRED EMBODIMENTS

The following embodiments refer to the accompanying drawings for exemplifying specific implementable embodiments of the present disclosure. The directional terms depicted by the present disclosure, such as upper, lower, front, back, left, right, inner, outer, side, or the likes, are only directions by referring to the accompanying drawings, and thus the used directional terms are used to illustrate and understand the present disclosure, but the present disclosure is not limited thereto. In the drawings, the same reference denotation represents the same or similar components.

The present disclosure aims at the technical problems of serious heat generation of the Gate Driver on Array (GOA) signal line on the via hole position, corrosion to the via hole invaded by water vapor, and the abnormal function of the GOA signal line caused by the particles falling into the via hole due to the contact between the frame sealant covering the GOA signal line and the GOA signal line in the conventional liquid crystal display panel. The present embodiments solve the above technical defects.

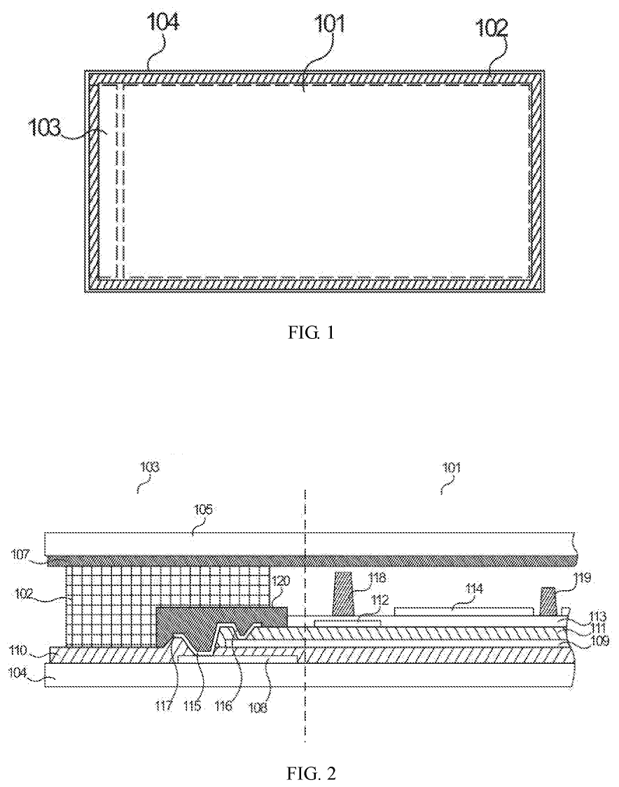

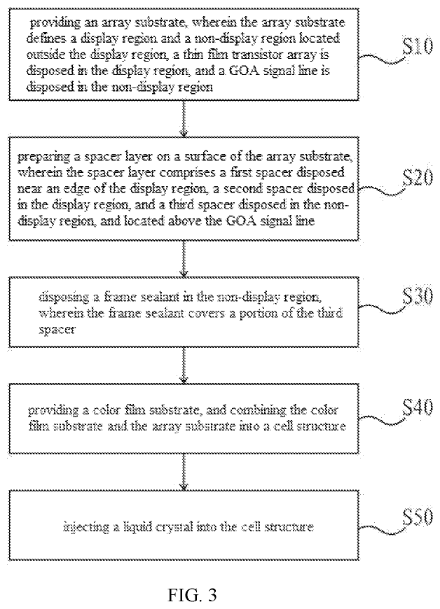

As shown in FIG. 1 and FIG. 2, the liquid crystal display panel provided by the present disclosure includes an array substrate 104, and a color filter substrate 105 disposed opposite to the array substrate 104. A frame sealant 102 is disposed in the border region between the array substrate 104 and the color filter substrate 105. The array substrate defines a display region 101 and a non-display region 103. The non-display region 103 is located near at least one end of the display region 101. A surface of the color filter substrate 105 is provided with a color resist layer 107.

A thin film transistor array is disposed in the display region 101, and the thin film transistor is configured to control whether to pass a current to pixel electrodes in the corresponding subpixels. After the current is passed to the pixel electrodes, a potential difference is formed between the pixel electrodes and the common electrodes, thereby controlling the liquid crystal deflection in the corresponding subpixels, and further realizing gray scale control of the corresponding subpixels.

The non-display region 103 of the array substrate is provided with the frame sealant 102, and the frame sealant 102 is configured for combining the array substrate and the color filter substrate into a cell structure.

A GOA signal line is disposed in the non-display region 103 on a surface of the array substrate 104. The GOA signal line includes a timing signal line 108, and the timing signal line 108 is connected to a scan line 109. For example, the timing signal line 108 is disposed on a surface of the array substrate 104, and a first insulating layer 110 is disposed on a surface of the timing signal line 108. The scan line 109 is disposed on a surface of the first insulating layer 110, extended into the display region 101, and connected to the thin film transistor. A second insulating layer 111 is disposed on a surface of the scan line 109. A data line 112 is disposed on a surface of the second insulating layer 111. A passivation layer 113 is disposed on a surface of the data line 112. A pixel electrode 114 is disposed on a surface of the passivation layer 113. A first via hole 115 is defined on the surface of the first insulating layer 110. A second via hole 116 is defined on the surface of the second insulating layer 111. A transparent metal layer 117 is connected to the timing signal line 108 through the first via hole 115, and the transparent metal layer 117 is connected to the scan line 109 through the second via hole 116. That is, the timing signal line 108 is connected to the scan line 109 through the transparent metal layer 117.

A spacer layer is manufactured on the surface of the array substrate, and the spacer layer includes a first spacer 118, a second spacer 119, and a third spacer 120. The first spacer 118 is disposed near an edge of the display region 101. The second spacer 119 is disposed and distributed near the corresponding pixel electrodes 114 in the display region 101. The third spacer 120 is disposed in the non-display region 103, and located between the GOA signal line and the frame sealant 102. Optionally, the frame sealant 102 covers a portion of the third spacer 120.

The third spacer 120 covers the surface of the GOA signal line. For example, the third spacer 120 completely covers or partially covers the GOA signal line. Preferably, the third spacer 120 covers at least the via hole structure in the non-display region 103, thereby isolating the via hole structure from the frame sealant 102. Firstly, the third spacer 120 isolates the frame sealant 102 from the via hole structure. The via hole structure is prevented from being corroded by water vapor caused by the thermal vaporization of the frame sealant 102. Secondly, the third spacer 120 prevents the frame sealant 102 from contacting the transparent metal layer 117 on the surface of the via hole structure, and reduces the impedances between the transparent metal layer 117 and the timing signal line 108 connecting the transparent metal layer 117 or/and between the transparent metal layer 117 and the scan line 109, to solve the technical problem of high temperatures in the first via hole 115 and the second via hole 116 caused by the high impedances.

In general, the first spacer 118 and the second spacer 119 are disposed between the array substrate and the color filter substrate in the liquid crystal display panel. The height of the first spacer 118 is greater than the height of the second spacer 119. When the liquid crystal display panel is pressed, the first spacer 118 firstly receives all of the pressure. When the pressure reaches the pressure threshold which the first spacer 118 can withstand, the second spacer 119 supports the first spacer 118 and receives a part of the pressure, and the first spacer 118 and the second spacer 119 cooperate to maintain the interval between the array substrate and the color filter substrate to a certain height. The main spacer and the second spacer 119 are formed on the surface of the array substrate by using a same mask process.

In the embodiment of the present disclosure, in order to reduce the manufacturing process, the third spacer 120 is made from the same material as the first spacer 118 and the second spacer 119. Thus, the first spacer 118, the second spacer 119 and the third spacer 120 can be manufactured on the surface of the array substrate, by using the same mask process. For example, the third spacer 120 is made from a negative photosensitive material.

Preferably, the three spacers 120 are manufactured, by using an ultraviolet (UV)-curable acrylic resin material.

In order to prevent the third spacer 120 from affecting the interval height between the array substrate and the color filter substrate, and prevent the third spacer 120 from affecting the fiber material in the frame sealant 102 to support the edge region in the liquid crystal display panel, the manufactured thickness of the spacer layer should be smaller than the thickness of the second spacer 119. Moreover, in order to simultaneously form the three spacers with different thicknesses on the surface of the array substrate, it is required to provide a combined mask. After the photosensitive material layer coated on the surface of the array substrate is subjected to a single exposure and development process, by using the combined mask, the spacers with different thicknesses can be formed in the different predetermined regions.

The combined mask includes a light transmissive region and a light shielding region, the light transmissive region is utilized for forming a pattern on a surface of the photosensitive material layer, and the light transmissive region includes a first subregion, a second subregion, and a third subregion, wherein the first subregion is configured to form the first spacer 118, the second subregion is configured to form the second spacer 119, the third subregion is configured to form the third spacer 120. For example, a normal mask is adopted for the first sub-region and has a transmittance of 100%, and half-tone masks (HTM) are adopted for the second sub-region and the third sub-region, such that the transmittance of the second subregion is less than 100%, and the transmittance of the third subregion is less than the transmittance of the second subregion. For example, gray tone masks (GTM) are adopted for the first subregion, the second subregion, and the third subregion. Gray tone masks utilize a slit diffraction principle to control the light transmittance. Different light transmittances are achieved by designing different slit distances. The slit width of the first subregion is smaller than the slit width of the second subregion. The slit width of the second sub-region is smaller than the slit width of the third sub-region.

The third spacer 120 has a thickness ranging from 0.2 um to 0.8 um. Preferably, the third spacer 120 has a thickness of 0.5 um.

After the manufacture of the third spacer 120 is completed, the frame sealant 102 is coated on the surface of the array substrate, the frame sealant 102 covers the surface of the third spacer 120, and the frame sealant 102 is isolated by the third spacer 120 from the via hole structure under the third spacers 120. A suitable sized fiber material is selected for the frame sealant 102 for properly matching the third spacer 120, and effectively supporting the edge regions of the liquid crystal display panel in the different intervals.

In accordance with the above object of the present disclosure, a method for manufacturing a liquid crystal display panel is provided. As shown in FIG. 3, the method includes steps of:

S10: providing an array substrate, wherein the array substrate defines a display region and a non-display region located outside the display region, a thin film transistor array is disposed in the display region, and a gate driver on array (GOA) signal line is disposed in the non-display region.

S20: preparing a spacer layer on a surface of the array substrate, wherein the spacer layer comprises a first spacer disposed near an edge of the display region, a second spacer disposed in the display region, and a third spacer disposed in the non-display region, and located above the GOA signal line;

S30: disposing a frame sealant in the non-display region, wherein the frame sealant covers a portion of the third spacer;

S40: providing a color filter substrate, and combining the color filter substrate and the array substrate into a cell structure;

S50: injecting a liquid crystal into the cell structure.

Preferably, in the step S20, the first spacer, the second spacer and the third spacer are prepared by using a same mask process, wherein thicknesses of a first spacer, the second spacer, and the third spacer successively decrease.

Preferably, in the step S20, the first spacer, the second spacer, and the third spacer are made of an ultraviolet (UV)-curable acryl resin material.

Preferably, the GOA signal line includes a timing signal line, an insulating layer is disposed on the timing signal line, a scan line is disposed on a surface of the insulating layer, the scan line extends into the display region and is connected to the thin film transistor array, the timing signal line is approximately perpendicular to the scan line; the timing signal line is connected to the scan line through the via holes, the transparent metal layer is formed on the surfaces of the via holes and configured to implement the connection between the timing signal line and the scan line. And, the third spacer covers at least the via holes.

The beneficial effects of the present disclosure are as follows: In the liquid crystal display panel and the method for manufacturing the same provided by the present disclosure, an isolation layer is disposed on the surface of the GOA signal line to avoid contact between the frame sealant covering the GOA signal line and the GOA signal line, thereby solving the defects of serious heat generation of the GOA signal line on the via hole position, corrosion to the via hole invaded by water vapor, and the abnormal function of the GOA signal line caused by the particles falling into the via hole due to the frame sealant covering a part of the GOA signal line.

In summary, although the preferable embodiments of the present disclosure have been disclosed above, the embodiments are not intended to limit the present disclosure. A person of ordinary skill in the art, without departing from the spirit and scope of the present disclosure, can make various modifications and variations. Therefore, the scope of the disclosure is defined in the claims.

What is claimed is:

1. A liquid crystal display panel, comprising:
an array substrate;
a color filter substrate disposed opposite to the array substrate; and
a frame sealant disposed between the array substrate and the color filter substrate;
wherein the array substrate comprises:
a display region;
a non-display region located outside the display region;
a thin film transistor array disposed in a display region of the array substrate;
a gate driver on array (GOA) signal line disposed in the non-display region of the array substrate; the frame sealant being located above the GOA signal line; and
a spacer layer comprising:
a first spacer disposed near an edge of the display region;
a second spacer disposed and distributed in the display region; and
a third spacer disposed in the non-display region, located between the GOA signal line and the frame sealant, and completely covers or partially covers the GOA signal line.

2. The liquid crystal display panel as claimed in claim 1, wherein the first spacer, the second spacer, and the third spacer are made from a same material.

3. The liquid crystal display panel as claimed in claim 2, wherein the first spacer, the second spacer, and the third spacer are made from a ultraviolet (UV)-curable acryl resin material.

4. The liquid crystal display panel as claimed in claim 1, wherein the first spacer, the second spacer, and the third spacer are formed on a surface of the array substrate by using a same mask process, wherein thicknesses of the first spacer, the second spacer, and the third spacer successively decrease.

5. The liquid crystal display panel as claimed in claim 4, wherein the third spacer has a thickness ranging from 0.2 um to 0.8 um.

6. The liquid crystal display panel as claimed in claim 1, wherein
the GOA signal line includes a timing signal line, a first insulating layer is disposed on the timing signal line, a scan line is disposed on a surface of the first insulating layer, a second insulating layer is disposed on a surface of the scan line, the scan line extends into the display region and is connected to the thin film transistor array, the timing signal line is approximately perpendicular to the scan line;
a first via hole is formed on the surface of the first insulating layer, a second via hole is formed on the surface of the second insulating layer, a transparent metal layer is formed on surfaces of the first via hole and the second via hole, the transparent metal layer is connected to the timing signal line through the first via hole, and the transparent metal layer is connected to the scan line through the second via hole, and the third spacer at least covers the first via hole and the second via hole.

7. A liquid crystal display panel, comprising:
an array substrate;
a color filter substrate disposed opposite to the array substrate; and
a frame sealant disposed between the array substrate and the color filter substrate;
wherein the array substrate comprises:
a display region;
a non-display region located outside the display region;
a thin film transistor array disposed in a display region of the array substrate;
a gate driver on array (GOA) signal line disposed in the non-display region of the array substrate; the frame sealant being located above the GOA signal line; and
a spacer layer comprising:
a first spacer disposed near an edge of the display region;
a second spacer disposed and distributed in the display region; and
a third spacer disposed in the non-display region, and located between the GOA signal line and the frame sealant.

8. The liquid crystal display panel as claimed in claim 7, wherein the first spacer, the second spacer, and the third spacer are made from a same material.

9. The liquid crystal display panel as claimed in claim 8, wherein the first spacer, the second spacer, and the third spacer are made from a ultraviolet (UV)-curable acryl resin material.

10. The liquid crystal display panel as claimed in claim 7, wherein the first spacer, the second spacer, and the third spacer are formed on a surface of the array substrate by using a same mask process, wherein thicknesses of the first spacer, the second spacer, and the third spacer successively decrease.

11. The liquid crystal display panel as claimed in claim 10, wherein the third spacer has a thickness ranging from 0.2 um to 0.8 um.

12. The liquid crystal display panel as claimed in claim 7, wherein
the GOA signal line includes a timing signal line, a first insulating layer is disposed on the timing signal line, a scan line is disposed on a surface of the first insulating layer, a second insulating layer is disposed on a surface of the scan line, the scan line extends into the display region and is connected to the thin film transistor array, the timing signal line is approximately perpendicular to the scan line;
a first via hole is formed on the surface of the first insulating layer, a second via hole is formed on the surface of the second insulating layer, a transparent metal layer is formed on surfaces of the first via hole and the second via hole, the transparent metal layer is connected to the timing signal line through the first via hole, and the transparent metal layer is connected to the scan line through the second via hole, and the third spacer at least covers the first via hole and the second via hole.

13. A method of manufacturing a liquid crystal display panel, comprising steps of:
S10: providing an array substrate, wherein the array substrate defines a display region and a non-display region located outside the display region, a thin film transistor array is disposed in the display region, and a gate driver on array (GOA) signal line is disposed in the non-display region;
S20: preparing a spacer layer on a surface of the array substrate, wherein the spacer layer comprises a first spacer disposed near an edge of the display region, a second spacer disposed in the display region, and a third spacer disposed in the non-display region, and located above the GOA signal line;
S30: disposing a frame sealant in the non-display region, wherein the frame sealant covers a portion of the third spacer;
S40: providing a color filter substrate, and combining the color filter substrate and the array substrate into a cell structure; and
S50: injecting a liquid crystal into the cell structure.

14. The method as claimed in claim 13, wherein in the step S20, the first spacer, the second spacer and the third spacer are prepared by using a same mask process, wherein thicknesses of a first spacer, the second spacer, and the third spacer successively decrease.

15. The method as claimed in claim 14, wherein in the step S20, the first spacer, the second spacer, and the third spacer are made of a ultraviolet (UV)-curable acryl resin material.

16. The method as claimed in claim 13, wherein
the GOA signal line includes a timing signal line, a first insulating layer is disposed on the timing signal line, a scan line is disposed on a surface of the first insulating layer, a second insulating layer is disposed on a surface of the scan line, the scan line extends into the display region and is connected to the thin film transistor array, the timing signal line is approximately perpendicular to the scan line;
a first via hole is formed on the surface of the first insulating layer, a second via hole is formed on the surface of the second insulating layer, a transparent metal layer is formed on surfaces of the first via hole and the second via hole, the transparent metal layer is connected to the timing signal line through the first via hole, and the transparent metal layer is connected to the scan line through the second via hole, and the third spacer at least covers the first via hole and the second via hole.
